(19) United States
(12) Patent Application Publication
(10) Pub. No.: US 2010/0204950 A1
(43) Pub. Date: Aug. 12, 2010

(54) AUTOMATED TEST FOR CONSUMER ELECTRONICS

(75) Inventors: Prisciliano Flores, Spring Valley, CA (US); Viral Mehta, San Diego, CA (US); Hung Nguyen, Oceanside, CA (US); Manish Sharma, San Diego, CA (US); Christopher Walsh, San Diego, CA (US); True Xiong, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/368,638

(22) Filed: Feb. 10, 2009

(51) Int. Cl. G06F 19/00; G06F 15/00

(52) U.S. Cl. 702/123; 702/182

(57) ABSTRACT

A method for testing a consumer electronics (CE) product that wirelessly receives user commands from an IR remote control includes obtaining command codes from the remote and correlating the command codes to respective functions. A tester can generate a test script designating the functions but the tester is not required to designate the command codes. In this way, the script can be executed by wirelessly transmitting to the CE product command codes corresponding to the functions designated in the script. During script execution, the CE product is queried for health indicia such as memory usage. The CE product sends the product health indicia to a test computer over a USB debug port.

### FIELD OF THE INVENTION

The present application relates generally to automated testing of consumer electronics, such as audio/video components including TVs.

### BACKGROUND OF THE INVENTION

Among the many steps to bring a consumer electronics (CE) product such as a TV, optical disk player, etc. is testing product performance for quality assurance. To this end, functional tests can be performed to test whether a product operates properly under various operational scenarios. This is particularly important given that most CE devices now accept a large number of user commands that might be input in combinations and/or time sequences that are not easily anticipated by the product designer.

### SUMMARY OF THE INVENTION

As understood herein, testing of CE products may be undertaken by imposing a scripted set of operations on the products and then observing how the products perform. As further understood herein, it is preferable that scripts can be easily authored by testers who might not be familiar with programming jargon, and that scripts authored for one manufacturer's product preferably can be used to test a similar product from a different manufacturer that might use different codes. Present principles further understand that test monitoring preferably can be done automatically and in accordance with the script author's preferences.

Accordingly, a method for testing a consumer electronics (CE) product that is configured to wirelessly receive user commands from a wireless input device includes obtaining command codes from the wireless input device, and correlating the command codes to respective functions. The method also includes permitting a tester to generate a test script designating at least some of the functions but not requiring the tester to designate the command codes. The script is executed by wirelessly transmitting, to the CE product, command codes corresponding to the functions designated in the script. During script execution, the CE product is queried for at least one product health index such as memory usage that represents the capability of the CE product to satisfactorily execute the script. The product health index is received over an output port of the product and presented to a tester.

The wireless input device can be an infrared (IR) remote control, in which case the script is executed by wirelessly transmitting, to the CE product, IR command codes corresponding to the functions designated in the script. The command codes can be obtained from the wireless input device by operating the device to transmit the command codes wirelessly and intercepting the command codes using a wireless receiver. Also, the command codes may be correlated to respective functions by a tester correlating the codes to functions in a data structure.

In example embodiments the product health index is received at a universal serial bus (USB) debugging port of the CE product. Queries for health indicia may be embedded in the script or sent via a wired link to the port.

In another aspect, a system has a wireless user command receiver and a test computer receiving command codes generated by a consumer electronics (CE) device remote control and intercepted by the receiver. The test computer stores the command codes in a data structure correlating the codes to respective CE product functions. The system further includes a script transmitter wirelessly sending, to the CE product, user commands embedded in a test script accessible to the test computer. The test computer periodically, during execution of the script, receives from the CE product information representing capability of the CE product to execute the script.

In another aspect, a method includes executing a test script by wirelessly transmitting, to a CE product, command codes corresponding to functions of the CE product. The method also includes, during script execution, querying the CE product for at least one indication of product performance. The indication of product performance represents a capability of the CE product to satisfactorily execute the script. The method includes receiving from the CE product the indication of product performance over an output port of the product, and presenting the information of product performance to a tester.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system that can embody present principles; and

FIG. 2 is a flow chart of example logic that may use present principles.

### DETAILED DESCRIPTION OF THE PREFERRED EMBODIMENT

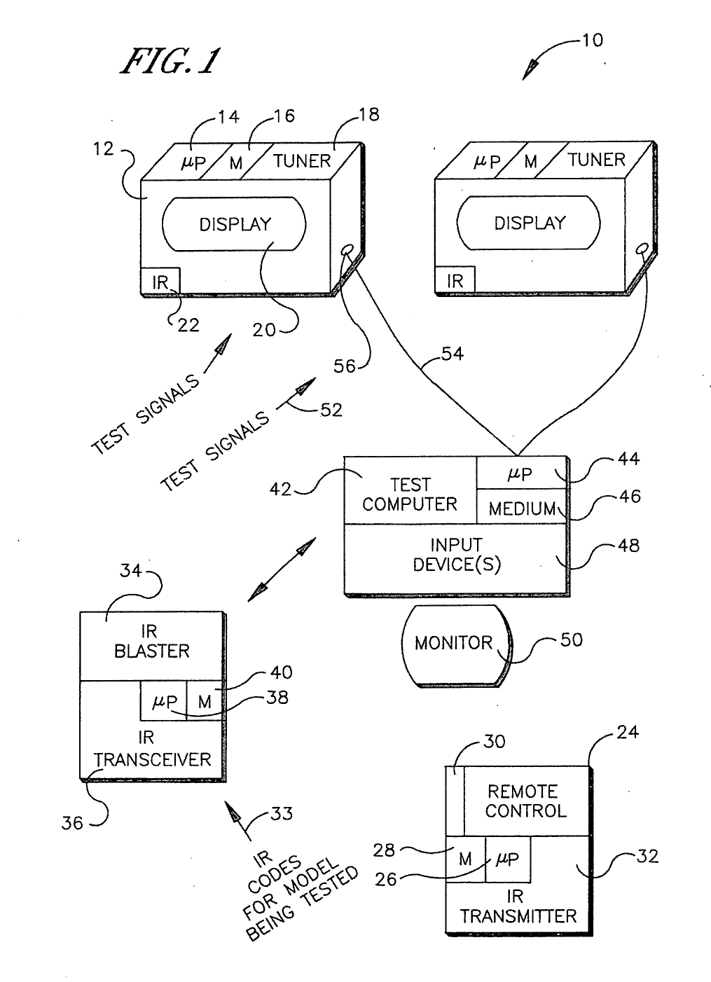

Referring initially to FIG. 1, a system is shown, generally designated 10, for testing one or more consumer electronics (CE) products 12. In the example shown, plural CE products 12 (only two shown for clarity) may be tested simultaneously with each other. Without limitation, the CE products 12 may be TVs as shown or other products such as disk players, personal video recorders, etc.

As shown in FIG. 1, a CE product 12 typically includes a CE processor 14 accessing software and data on one or more computer-readable media 16 such as but not limited: to solid state storage or disk-based storage. When the CE product 12 is a TV it also typically includes a TV tuner 18 and a TV display 20, such as a flat panel high definition and/or standard definition display. To cause the CE processor 14 to execute user commands, a wireless command receiver 22 such as an infrared (IR) receiver can be provided on the product to receive wireless user commands from a remote control 24, with the commands being input to the CE processor 14 to cause the CE product 12 to execute functions corresponding to the commands. By way of non-limiting illustration, commands can be input to the CE product 12 to cause it to change volume, change channel, display a programming guide, display a setup page, change display settings, etc.

FIG. 1 shows that the remote control 24 typically includes a remote processor 26 accessing software and data on one or more computer-readable media 28 such as but not limited to solid state storage or disk-based storage. A user can input commands to the remote processor 26 using, e.g., a keypad 30 on the remote control 24, which the remote processor 26 then causes to be transmitted by a typically IR or radio frequency (RF) transmitter 32 to the wireless receiver 22 of the CE product 12, which relays the commands to the CE processor 14 for execution thereof.

As indicated in FIG. 1, a tester can manipulate the remote control 24 to cause it to transmit command codes representing the desired user commands, and the wireless command codes can be intercepted (as indicated at 33 in FIG. 1) by a test transceiver assembly 34, labeled in FIG. 1 as “IR blaster”. The test transceiver assembly 34 may include a wireless transceiver 36 such as an IR transceiver, and a transceiver processor 38 accessing software and data on one or more computer-readable media 40 such as but not limited to solid state storage or disk-based storage.

Additionally, one or more test computers 42 may receive information from the test transceiver assembly 34. The computer 42 may include a test processor 44 accessing software and data on one or more computer-readable media 46 such as but not limited to solid state storage or disk-based storage. Test technician input may be received by the test processor 44 from one or more user input devices 48 such as mice, keyboards, etc. Also, information may be output on one or more output devices 50 such as a computer monitor, printer, or network.

The test computer 42 can cause the test transceiver assembly 34 to send to plural CE products 12 simultaneously command codes in accordance with the below-described script, as indicated at 52 in FIG. 1. The test computer 42 can also receive information from the CE products 12, discussed further below. In one implementation the information is received on respective wired links 54 which may be connected to output ports 56 of the CE products 12. The output ports 56 may be, e.g., universal serial bus (USB) debugging ports of the CE product, which are electrically connected to the respective CE processor 14 via, e.g., a printed circuit board. For example, the CE products 12 maybe connected to the circuit board using a ribbon cable and the circuit board connected to the test computer using a USB cable.

While FIG. 1 shows that wireless signals are received from the remote control 24 and sent to the CE products 12 by a single test transceiver assembly 34, it is to be understood that separate receivers and transmitters may be provided. It is to be further understood that all or parts of the test transceiver assembly 34 may be implemented by the test computer 42.

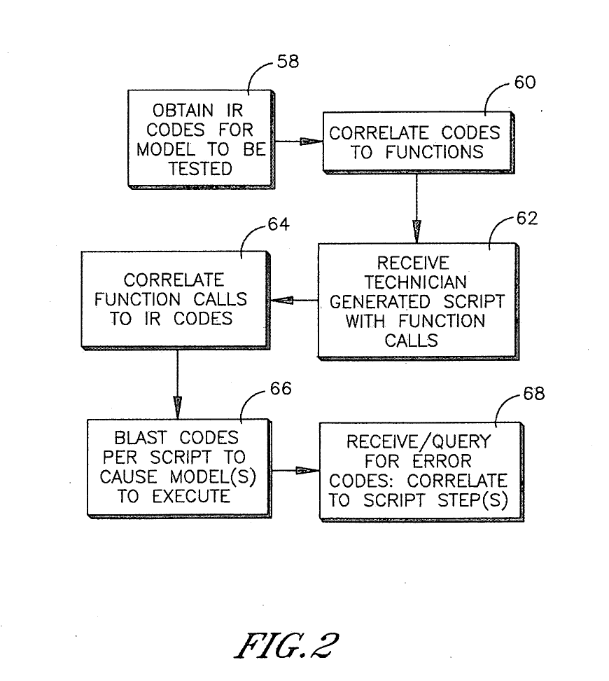

Now referring to FIG. 2, commencing at block 58 the command codes for the CE products 12 sought to be tested are obtained. In one implementation this is accomplished by operating the remote control 24 to cycle through all commands that can be input using the remote control 24 and intercepting the commands using the test transceiver assembly 34. At block 60, the command codes are correlated to respective CE product 12 functions and stored, e.g., by the test computer 42. The correlation may be manual, i.e., as each command code is captured a tester can manually input to the test computer 42 the respective function, learned either by observing the activity of the CE product 12 or using the label of the associated key or keys on the remote or knowing the codes themselves. Debugging information output by the CE product can be used to obtain the codes.

In other embodiments block 58 may be executed by connecting a link directly from the remote control 24 to the test computer 42 and downloading the command codes to the test computer 42. Or, the command codes may be directly input to the test computer 42 in numeric format using the input devices 48. The correlation at block 60 may alternatively be executed by importing, from, e.g., a manufacturer of the CE products 12, a data structure such as a table that already has command codes correlated to CE product functions. In any case, the test computer 42 stores, e.g., on its computer medium 46, a data structure such as a table that correlates command codes for wireless transmission to CE product functions.

With this in mind, it may now be appreciated that when the logic flows to block 62, a test technician can generate a test script simply by establishing an ordered list of CE product functions the technician wishes to run in sequence. The test technician is not required to input the command codes per se but only the desired product functions, relieving the test technician of having to know potentially lengthy strings of code. At block 64, the test computer 42 accesses the data structure correlating functions to command codes and creates a script by replacing the function calls in the test technician's input script to the equivalent command codes.

At test time, the script with command codes are then provided to the test transceiver assembly 34, which executes the script by wirelessly transmitting the command codes per instructions in the script to the CE products 12. This causes the CE products to execute the functions desired by the test technician.

As the CE products are caused to execute the functions of the script, at block 68 information is received from the CE products 12 by the test computer 42. The information may indicate product performance and thus may represent the capability of the CE product 12 to satisfactorily execute the script. In effect, “health” indicia are received from the CE products such as current CE product memory usage (e.g., the sum of free memory, buffers, and cache memory), error messages that might be generated by the CE processor 14, debugging codes including indications of CE product 14 restart, CE product processor load, etc.

In one implementation, the information received by the test computer 42 at block 68 may be received over the wired links 54 through the ports 56 of the CE products 12. The CE product being tested can send indications to the test computer of what commands were received from the remote control, and the test computer parses the information to separate remote control command indications from debugging information and correlate the two.

The information may simply be monitored for by the test computer 42 and recorded as it might appear on a debug bus to which the port 56 is connected. More preferably, in addition to or in lieu of passively monitoring for information as it is output by the CE processor 14, the test computer 42 can affirmatively query the CE processor 14 for the information. The querying may be part of the script that is transmitted by the test transceiver assembly 34 or it may be undertaken over the links 54. In any case, it may now be appreciated that the test technician authoring the script can specify what health indicia are queried for when, so that at any desired point in script execution, the health of the CE product 12 can be ascertained from health information that was stored on tangible computer storage. The results of block 68 may be presented to the test technician for subsequent corrective action, if any, e.g., for software modification to the CE product processor 14.

While the particular AUTOMATED TEST FOR CONSUMER ELECTRONICS is herein shown and described in detail, it is to be understood that the subject matter which is encompassed by the present invention is limited only by the claims.

What is claimed is:

1. Method for testing a consumer electronics (CE) product configured to wirelessly receive user commands from a wireless input device, comprising:
obtaining command codes from the wireless input device;
correlating the command codes to respective functions;
permitting a tester to generate a test script designating at least some of the functions but not requiring the tester to designate the command codes;
executing the script by wirelessly transmitting, to the CE product, command codes corresponding to the functions designated in the script;
during script execution, querying the CE product for at least one product health index, the product health index being representative of a capability of the CE product to satisfactorily execute the script;
receiving from the CE product the product health index over an output port of the product; and
presenting the product index to a tester.

2. The method of claim 1, wherein the wireless input device is a remote control.

3. The method of claim 2, wherein the remote control transmits infrared (IR) user commands.

4. The method of claim 3, wherein the script is executed by wirelessly transmitting, to the CE product, IR command codes corresponding to the functions designated in the script.

5. The method of claim 1, wherein the command codes are obtained from the wireless input device by operating the device to transmit the command codes wirelessly and intercepting the command codes using a wireless receiver, and/or from debugging information output by the CE product.

6. The method of claim 5, wherein the command codes are correlated to respective functions by a tester correlating the codes to functions in a data structure.

7. The method of claim 1, wherein the product health index is received at a universal serial bus (USB) debugging port of the CE product.

8. The method of claim 1, wherein queries for health indicia are embedded in the script.

9. The method of claim 1, wherein queries for health indicia are sent via a wired link to the port.

10. The method of claim 1, wherein the health index includes CE product memory usage.

11. System comprising:
wireless user command receiver;
test computer receiving command codes generated by a consumer electronics (CE) device remote control and intercepted by the receiver, the test computer storing the command codes in a data structure correlating the codes to respective CE product functions;
script transmitter wirelessly sending, to the CE product, user commands embedded in a test script accessible to the test computer; wherein
the test computer periodically, during execution of the script, receives from the CE product information representing capability of the CE product to execute the script.

12. The system of claim 11, wherein the wireless user command receiver is embodied with the script transmitter.

13. The system of claim 11, wherein the test computer periodically queries the CE product for the information.

14. The system of claim 13, wherein the information is received at a test bus output port of the CE product.

15. Method, comprising:
executing a test script by wirelessly transmitting, to a CE product, command codes corresponding to functions of the CE product;
during script execution, querying the CE product for at least one indication of product performance, the indication of product performance being representative of a capability of the CE product to satisfactorily execute the script;
receiving from the CE product the indication of product performance over an output port of the product; and
presenting the information of product performance to a tester.

16. The method of claim 15, comprising:
obtaining the command codes from a wireless input device configured to input user commands to the CE product;
correlating the command codes to respective functions;
permitting a tester to generate a test script designating at least some of the functions but not requiring the tester to designate the command codes.

17. The method of claim 15, wherein the script is executed by wirelessly transmitting, to the CE product, IR command codes corresponding to the functions designated in the script.

18. The method of claim 15, wherein the indication of product performance is received at a universal serial bus (USB) debugging port of the CE product.

19. The method of claim 15, wherein queries for indication of product performance are embedded in the script.

20. The method of claim 15, wherein queries for indication of product performance are sent via a wired link to the CE product.

21. The method of claim 15, wherein the indication of product performance includes CE product memory usage.
